(19) United States
(12) Patent Application Publication
(10) Pub. No.: US 2007/0036172 A1
(43) Pub. Date: Feb. 15, 2007

(54) Methods, systems, and computer program products for provisioning a digital subscriber line in which an incumbent local exchange carrier activates a line number port on behalf of a competitive local exchange carrier

(76) Inventor: Tingting Lu, Alpharetta, GA (US)

Correspondence Address: MYERS BIGEL SIBLEY & SAJOVEC, P.A., P.O. BOX 37428, RALEIGH, NC, 27627, US

(21) Appl. No.: 11/297,186

(22) Filed: Dec. 8, 2005

Related U.S. Application Data
(60) Provisional application No. 60/700,276, filed on Jul. 18, 2005.

(51) Int. Cl. H04M 1/00

(52) U.S. Cl. 370/463; 379/399.01

(57) ABSTRACT

A digital subscriber line (DSL) is provisioned by porting a telephone number from an Incumbent Local Exchange Carrier (ILEC) to a Competitive Local Exchange Carrier (CLEC) that provides Central Office Voice over Network (CO-VoN) service. The DSL is provisioned to use a shadow line telephone number with hotline service to route originating calls to a softswitch complex. The DSL is provisioned with calling name to identify a party associated with an incoming call. A line number port activation command is issued at the ILEC for the CLEC so that incoming calls to the DSL are routed through the softswitch complex.

### RELATED APPLICATION

This application claims the benefit of and priority to U.S. Provisional Patent Application No. 60/700,276, filed Jul. 18, 2005, the disclosure of which is hereby incorporated herein by reference as if set forth in its entirety.

### FIELD OF THE INVENTION

The present invention relates to communication networks and methods of operating the same, and, more particularly, to methods, system, and computer program products for provisioning digital subscriber lines (DSLs) in communication networks.

### BACKGROUND OF THE INVENTION

Internet telephony, also referred to herein as Voice-Over Internet Protocol (VoIP), Voice-Over Network (VoN), and/or Internet Protocol Telephony (IP Telephony), is becoming increasingly popular due, in part, to marked improvements in reliability and sound quality of the service. The improved performance of Internet telephony communications may be due to upgrades made to the Internet backbone through improved switching fabrics, such as Asynchronous Transfer Mode (ATM) fabrics, and to implementation of new communications standards, such as standards for transport protocols, directory services, and/or audio codec format.

Currently, to provide Internet telephony communications to a customer, a customer obtains equipment, such as Integrated Access Devices (IADs), Analog Terminal Adaptors (ATAs), telephone adapters (TAs), and the like, to be installed at the customer's premises, for example, a customer's home. The equipment is used to support a voice path within the premises and through a broadband connection, for example, a digital subscriber line (DSL) connection, back to an Internet Service Provider (ISP). Once the necessary equipment is installed, customers/subscribers can connect their existing analog phones, for example, Plain Old Telephone Service (POTS) phones, to the ATA(s). The ATA(s) provide such functionality as dial tone, battery, and power ringing as part of providing POTS functionality through the VoN service. Normally, a Central Office (CO) switch provides dial tone, battery, and power ringing for analog phones.

Unfortunately, when a customer subscribes to a VoN service, such as Central Office VoN (CO-VON), provisioning of the service, including provisioning of a DSL line currently used by the subscriber, may result in an undesirably long DSL service outage.

### SUMMARY OF THE INVENTION

According to some embodiments of the present invention, a digital subscriber line (DSL) is provisioned by porting a telephone number from an Incumbent Local Exchange Carrier (ILEC) to a Competitive Local Exchange Carrier (CLEC) that provides Central Office Voice over Network (CO-VoN) service. The DSL is provisioned to use a shadow line telephone number with hotline service to route originating calls to a softswitch complex. The DSL is provisioned with calling name to identify a party associated with an incoming call. A line number port activation command is issued at the ILEC for the CLEC so that incoming calls to the DSL are routed through the softswitch complex.

In other embodiments of the present invention, Plain Old Telephone Service (POTS) is canceled on the DSL.

In still other embodiments of the present invention the telephone number is ported from the CLEC that provides CO-VoN service to the ILEC. The shadow line number and the hotline service used to route originating calls on the DSL to the softswitch complex are canceled and Plain Old Telephone Service (POTS) on the DSL is provisioned using the telephone number.

In still other embodiments of the present invention, the DSL is provisioned with the telephone number before porting the telephone number if the shadow line number is hidden from an end user of the DSL. Provisioning the DSL to use the shadow line number comprises modifying the DSL to replace the telephone number with the shadow line number.

In still other embodiments of the present invention, porting the telephone number is performed before provisioning the DSL to use the shadow line number.

In still other embodiments of the present invention, the DSL is disassociated with the telephone number and the DSL is associated with a circuit identifier in a communications network.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 illustrates a communication network that illustrates provisioning a DSL line in which an Incumbent Local Exchange Carrier (ILEC) issues a line number port activation command on behalf of a Competitive Local Exchange Carrier (CLEC) in accordance with some embodiments of the present invention; and

FIG. 2 is a flowchart that illustrates operations for provisioning a DSL line in which an ILEC issues a line number port activation command on behalf of a CLEC in accordance with some embodiments of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

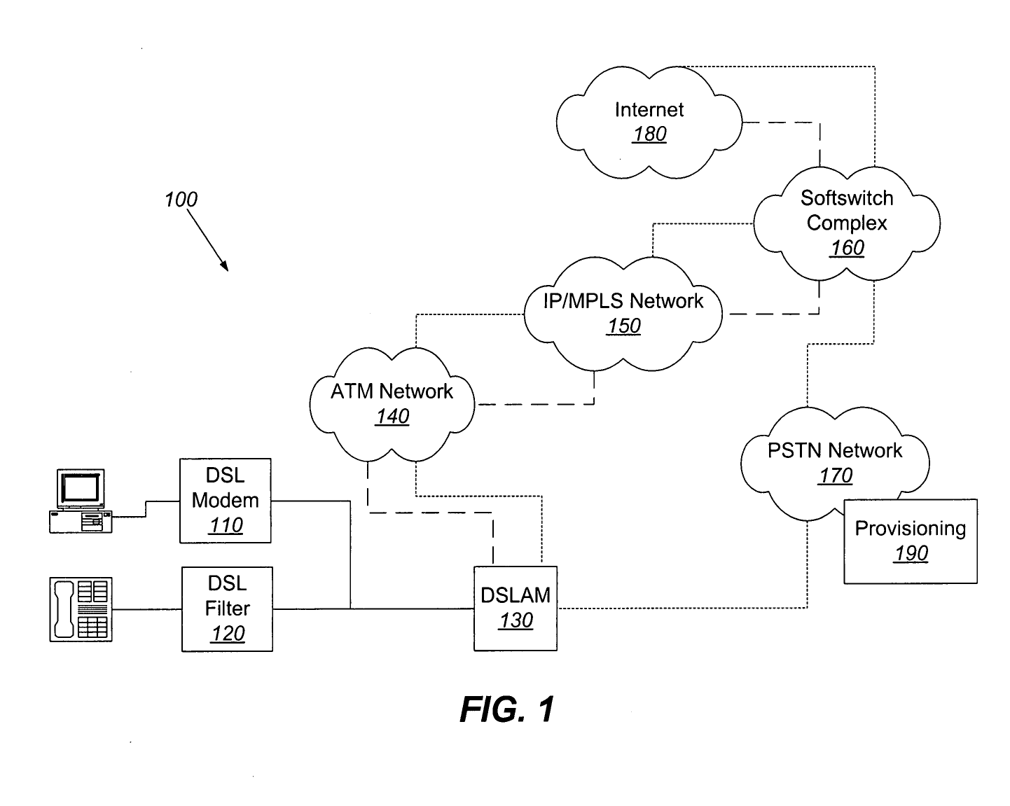

Referring now to FIG. 1, an exemplary communication network 300 in which a Digital Subscriber Line (DSL) may be provisioned such that an Incumbent Local Exchange Carrier (ILEC) issues a line number port activation command on behalf of a Competitive Local Exchange Carrier (CLEC), in accordance with some embodiments of the present invention, will now be described. The communication network 100 includes customer premises devices, such as a computer and analog phone, that are connected to a DSL via a DSL modem 110 and DSL filter 120, respectively. The DSL terminates at a Digital Subscriber Line Access Multiplexer (DSLAM) 130 where multiple DSL lines are typically multiplexed and the voice and data components are aggregated for transmission over the network. As shown in FIG. 1, if a customer subscribes to IP-VoN service, then voice and data components are aggregated for transmission over an ATM network 140, an Internet Protocol/Multiprotocol Label Switching (IP/MPLS) network 150, and a softswitch complex 160. In general, the softswitch complex 160 may provide an interface between circuit switched networks and packet switched networks, such as between the PSTN network 170 and the Internet 180. The softswitch complex 160 may comprise elements, such as a softswitch, media server, and trunk gateway that is used to established connections to the PSTN network 170. Thus, as shown in FIG. 1, voice traffic may be routed to the PSTN network via a trunk gateway while data traffic may be routed to the Internet 180. In some embodiments, voice traffic may also be routed via the Internet.

A customer may also subscribe to Central Office Voice over Network (CO-VoN) in which data traffic is routed from the DSLAM 130 through the ATM network 140, IP/MPLS network 150, softswitch complex 160, and Internet 180 while voice traffic is routed from the DSLAM 130 through the PSTN network 170 to the softswitch complex 160 via a trunk gateway. The ILEC may provide a shadow line number for the DSL along with a hotline service so that originating calls are automatically routed to the softswitch complex 160. The ILEC may also provide a calling name feature for the DSL to provide an identification of a calling party.

The PSTN network may include a DSL provisioning function 190 that may include the processing and storage resources for provisioning and managing DSL lines in the ILEC network. The DSL provisioning function may include the ordering programs that are used to provision service for end customers as well as CLEC customers. This may include, but is not limited to, receiving orders associated with end customers and/or CLECs, porting telephone numbers between the ILEC and the CLECs, and/or provisioning features on the DSL lines and other ILEC facilities. Advantageously, the provisioning function 190 may be configured to issue a line number port activation command on behalf of the CLEC so that incoming calls to the DSL are routed through the softswitch complex 160. That is, the provisioning function 190 may be configured to sequence the operations involved in provisioning the DSL, including porting the telephone number to the CLEC, when a customer subscribes to CO-VoN service. By performing the line number port activation at the ILEC on behalf of the CLEC, the provisioning function 190 may act as a service bureau for the CLEC and the amount of time that service is interrupted on the DSL may be reduced.

Although FIG. 1 illustrates an exemplary communication network, it will be understood that the present invention is not limited to such configurations, but is intended to encompass any configuration capable of carrying out the operations described herein.

Computer program code for carrying out operations of the DSL provisioning function 190 may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

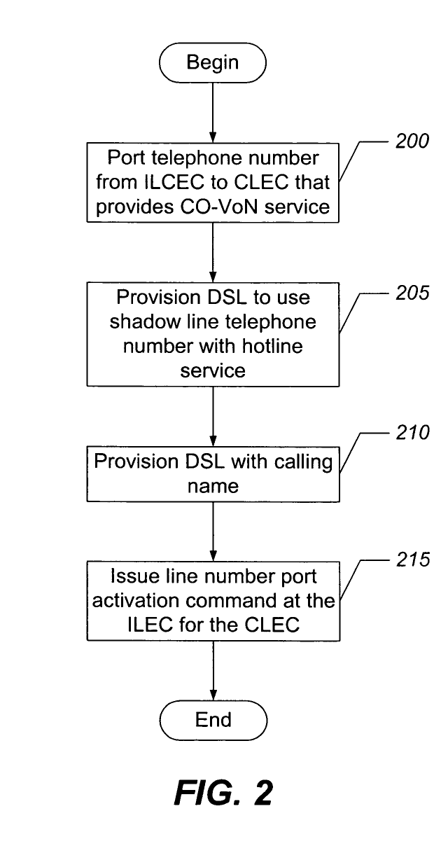

Exemplary operations for provisioning a DSL such that an ILEC issues a line number port activation command on behalf of a CLEC will now be described with reference to FIGS. 2 and 1. Operations begin at block 200 where the telephone number is ported from the ILEC to the CLEC that provides the CO-VoN service. The DSL is provisioned to use a shadow line number with hotline service at block 205 so that originating calls are routed to the softswitch complex 160. The DSL is also provisioned with calling name to identify the party associated with an incoming call at block 210. The ILEC then issues a line number port activation command for the CLEC at block 215 to allow incoming calls to the DSL to be routed through the softswitch complex 160. In some embodiments, the POTS service may be canceled on the DSL as part of provisioning the DSL for CO-VoN service. As discussed above, by acting as a service bureau and sequencing the foregoing provisioning operations along with issuing the line number port activation, the ILEC may reduce the amount of time that service is disrupted on the DSL when a customer subscribes to CO-VoN service.

If the customer decides to cancel the CO-VoN service, then, in accordance with some embodiments of the present invention, the telephone number is ported from the CLEC that provides CO-VoN service to the ILEC. The shadow line number and the hotline service used to route originating calls on the DSL to the softswitch complex 160 are canceled and POTS on the DSL is provisioned using the telephone number.

The shadow line number may or may not be provided to the customer and/or the customer's Internet Service Provider (ISP) as part of the customer's CO-VoN service. If the shadow line number is provided to the customer and/or the ISP, then the telephone number is ported from the ILEC to the CLEC before the DSL is provisioned with the shadow line number. On the other hand, if the shadow line number is not provided to the customer and/or the ISP, then the DSL is provisioned with the telephone number before the telephone number is ported from the ILEC to the CLEC. The DSL is then provisioned such that the telephone number is modified with the shadow line number.

In other embodiments of the present invention, the DSL provisioning function 390 may be configured to disassociate the DSL with a telephone number and then associate the DSL with a circuit identifier. This may allow ILECs, CLECs, and/or other service providers to view telephone numbers as a logical and portable objects that are not necessarily tied to a specific physical facility. Moreover, management of the DSL is simplified as customers subscribe to IP-VoN and/or CO-VoN as these services may require porting a telephone number from an ILEC to a CLEC, which may require that the DSL be taken out of service if the DSL is managed based on telephone number. If the DSL is managed based on a circuit identification, however, then there may be no need to disrupt DSL service or the length of time that service is disrupted may be reduced.

The flowchart of FIG. 2 illustrates the architecture, functionality, and operations of some embodiments of methods, systems, and computer program products for provisioning a DSL such that an ILEC issues a line number port activation command on behalf of a CLEC. In this regard, each block represents a module, segment, or portion of code, which comprises one or more executable instructions for implementing the specified logical function(s). It should also be noted that in other implementations, the function(s) noted in the blocks may occur out of the order noted in FIG. 2. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

That which is claimed:

1. A method of provisioning a digital subscriber line (DSL), comprising:
porting a telephone number from an Incumbent Local Exchange Carrier (ILEC) to a Competitive Local Exchange Carrier (CLEC) that provides Central Office Voice over Network (CO-VoN) service;
provisioning the DSL to use a shadow line telephone number with hotline service to route originating calls to a softswitch complex;
provisioning the DSL with calling name to identify a party associated with an incoming call; and
issuing a line number port activation command at the ILEC for the CLEC so that incoming calls to the DSL are routed through the softswitch complex.

2. The method of claim 1, further comprising:
canceling Plain Old Telephone Service (POTS) on the DSL.

3. The method of claim 1, further comprising:
porting the telephone number from the CLEC that provides CO-VoN service to the ILEC;
canceling the shadow line number and the hotline service used to route originating calls on the DSL to the softswitch complex; and
provisioning Plain Old Telephone Service (POTS) on the DSL using the telephone number.

4. The method of claim 1, further comprising:
provisioning the DSL with the telephone number before porting the telephone number if the shadow line number is hidden from an end user of the DSL; and
wherein provisioning the DSL to use the shadow line number comprises modifying the DSL to replace the telephone number with the shadow line number.

5. The method of claim 1, wherein porting the telephone number is performed before provisioning the DSL to use the shadow line number.

6. The method of claim 1, further comprising:
disassociating the DSL with the telephone number; and
associating the DSL with a circuit identifier in a communications network.

7. A system for provisioning a digital subscriber line (DSL), comprising:
means for porting a telephone number from an Incumbent Local Exchange Carrier (ILEC) to a Competitive Local Exchange Carrier (CLEC) that provides Central Office Voice over Network (CO-VoN) service;
means for provisioning the DSL to use a shadow line telephone number with hotline service to route originating calls to a softswitch complex;
means for provisioning the DSL with calling name to identify a party associated with an incoming call; and
means for issuing a line number port activation command at the ILEC for the CLEC so that incoming calls to the DSL are routed through the softswitch complex.

8. The system of claim 7, further comprising:
means for canceling Plain Old Telephone Service (POTS) on the DSL.

9. The system of claim 7, further comprising:
means for porting the telephone number from the (CLEC) that provides CO-VoN service to the ILEC;
means for canceling the shadow line number and the hotline service used to route originating calls on the DSL to the softswitch complex; and
means for provisioning Plain Old Telephone Service (POTS) on the DSL using the telephone number.

10. The system of claim 7, further comprising:
means for provisioning the DSL with the telephone number before porting the telephone number if the shadow line number is hidden from an end user of the DSL; and
wherein the means for provisioning the DSL to use the shadow line number comprises means for modifying the DSL to replace the telephone number with the shadow line number.

11. The system of claim 7, further comprising:
means for disassociating the DSL with the telephone number; and
means for associating the DSL with a circuit identifier in a communications network.

12. A computer program product for provisioning a digital subscriber line (DSL), comprising:
a computer readable storage medium having computer readable program code embodied therein, the computer readable program code comprising:
computer readable program code configured to port a telephone number from an Incumbent Local Exchange Carrier (ILEC) to a Competitive Local Exchange Carrier (CLEC) that provides Central Office Voice over Network (CO-VoN) service;
computer readable program code configured to provision the DSL to use a shadow line telephone number with hotline service to route originating calls to a softswitch complex;
computer readable program code configured to provision the DSL with calling name to identify a party associated with an incoming call; and
computer readable program code configured to issue a line number port activation command at the ILEC for the CLEC so that incoming calls to the DSL are routed through the softswitch complex.

13. The computer program product of claim 12, further comprising:
computer readable program code configured to cancel Plain Old Telephone Service (POTS) on the DSL.

14. The computer program product of claim 12, further comprising:
computer readable program code configured to port the telephone number from the (CLEC) that provides CO-VoN service to the ILEC;
computer readable program code configured to cancel the shadow line number and the hotline service used to route originating calls on the DSL to the sof iswitch complex; and
computer readable program code configured to provision Plain Old Telephone Service (POTS) on the DSL using the telephone number.

15. The computer program product of claim 12, further comprising:
computer readable program code configured to provision the DSL with the telephone number before porting the telephone number if the shadow line number is hidden from an end user of the DSL; and
wherein the computer readable program code configured to provision the DSL to use the shadow line number comprises computer readable program code configured to modify the DSL to replace the telephone number with the shadow line number.

16. The computer program product of claim 12, further comprising:
computer readable program code configured to disassociate the DSL with the telephone number; and
computer readable program code configured to associate the DSL with a circuit identifier in a communications network.
